(19) United States
(12) Patent Application Publication
(10) Pub. No.: US 2007/0146948 A1
(43) Pub. Date: Jun. 28, 2007

(54) Integrated circuit arrangements

(76) Inventors: Daniel Kehrer, Munchen (DE); Hans-Dieter Wohlmuth, Munchen (DE)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/431,930

(22) Filed: May 10, 2006

(30) Foreign Application Priority Data
May 10, 2005 (DE) 102005021571.8-42

(51) Int. Cl. H02H 9/00

(52) U.S. Cl. 361/56

(57) ABSTRACT

An integrated multiplexer circuit arrangement and an integrated latch circuit arrangement is disclosed. In one embodiment, a transformer is set up and connected up in such a way that it electrically decouples a data signal circuit and a clock signal circuit, and that it makes a clock signal of the clock signal circuit available as a control signal for the data signal circuit. The transformer includes two secondary-side end terminals directly coupled to the data signal circuit and a secondary-side center terminal coupled to a bias current source.

### CROSS-REFERENCE TO RELATED APPLICATIONS

This Utility Patent Application claims priority to German Patent Application No. DE 10 2005 021 571.8-42, filed on May 10, 2005, which is incorporated herein by reference.

### BACKGROUND

The invention relates to integrated circuit arrangements.

Integrated circuit arrangements including a multiplexer or a latch register are used diversely in electronic circuits.

A multiplexer is an electronic circuit or assembly which selects a respective input signal from a specific number of input signals present at its inputs and switches it to its output. That is to say that an output signal is generated from a plurality of input signals which are applied to the multiplexer in parallel and which are present at the plurality of inputs. The selection of a respective input signal is effected by a control signal in this case.

The basic form of a multiplexer is a 2:1 multiplexer, which generates an output signal from two input signals applied to two parallel input channels, the output signal being transmitted via an output channel. The circuitry construction of a conventional 2:1 multiplexer 100 is explained in greater detail referring to FIG. 1.

A first data input 101 is coupled to the gate of a first transistor 102, the first source/drain region of which is coupled to a first node 103 and the second source/drain region of which is coupled to a second node 104. The first node 103 is coupled to a first source/drain region of a second transistor 105. The gate of the second transistor 105 is coupled to a second data input 106, which is differential with respect to the first data input 101. In the context of this application, two differential terminals is understood to mean that if a signal is present at one terminal, the inverse signal is present at the differential terminal with respect to the former terminal. A second source/drain region of the second transistor 105 is coupled to a third node 107. Furthermore, the first node 103 is coupled to a first source/drain region of a third transistor 108. The gate of the third transistor 108 is coupled to a first clock signal input 109. The second source/drain region of the third transistor 108 is coupled to a fourth node 110. The fourth node 110 is coupled to a terminal of a current source 111 and to a first source/drain region of a fourth transistor 112. The gate of the fourth transistor 112 is coupled to a second clock signal input 113, which second clock signal input 113 is differential with respect to the first clock signal input 109. The second source/drain region of the fourth transistor 112 is coupled to a fifth node 114. The fifth node 114 is coupled to a first source/drain region of a fifth transistor 115 and to a first source/drain region of a sixth transistor 116. The gate of the fifth transistor 115 is coupled to a third data input 117. A second source/drain region of the fifth transistor 115 is coupled to the second node 104. The gate of the sixth transistor 116 is coupled to a fourth data input 118, which is differential with respect to the third data input 117. A second source/drain region of the sixth transistor 116 is coupled to the third node 107.

The second node 104 is coupled to a sixth node 120 by a first impedance 119. The third node 107 is likewise coupled to the sixth node 120 by a second impedance 121.

The sixth node 120 is coupled to a terminal of a voltage source 122, which provides a supply voltage V_{DD}. The second node 104 is furthermore coupled to a first output terminal 123 of the circuit arrangement 100. The third node 107 is coupled to a second output terminal 124 of the circuit arrangement 100, which second output terminal 124 is differential with respect to the first output terminal 123.

A latch register (latch) is an electronic circuit or assembly which buffer-stores a specific number of input signals present at its inputs and provides them for read-out. A customary area of application of a latch register is the buffer-storage of data in a central processing unit (CPU). Clearly, a latch register (also referred to as a latch) is a state-controlled flip-flop. A latch register is transparent throughout the active clock phase, that is to say that a change in the input signal present immediately brings about a corresponding change in the output signal provided.

The circuitry construction of a conventional latch register (latch) 200 is explained in greater detail referring to FIG. 2.

A first data input 201 is coupled to the gate of a first transistor 202, the first source/drain region of which is coupled to a first node 203 and the second source/drain region of which is coupled to a second node 204. The first node 203 is coupled to a first source/drain region of a second transistor 205. The gate of the second transistor 205 is coupled to a second data input 206, which is differential with respect to the first data input 201. A second source/drain region of the second transistor 205 is coupled to a third node 207. Furthermore, the first node 203 is coupled to a first source/drain region of a third transistor 208. The gate of the third transistor 208 is coupled to a first clock signal input 209. The second source/drain region of the third transistor 208 is coupled to a fourth node 210. The fourth node 210 is coupled to a terminal of a current source 211 and to a first source/drain region of a fourth transistor 212. The gate of the fourth transistor 212 is coupled to a second clock signal input 213, which second clock signal input 213 is differential with respect to the first clock signal input 209. The second source/drain region of the fourth transistor 212 is coupled to a fifth node 214. The fifth node 214 is coupled to a first source/drain region of a fifth transistor 215 and to a first source/drain region of a sixth transistor 216. The gate of the fifth transistor 215 is coupled to the third node 207. A second source/drain region of the fifth transistor 215 is coupled to the second node 204. The gate of the sixth transistor 216 is coupled to the second node 204. A second source/drain region of the sixth transistor 216 is coupled to the third node 207.

The second node 204 is coupled to a sixth node 218 by a first impedance 217. The third node 207 is likewise coupled to the sixth node 218 by a second impedance 219.

The sixth node 218 is coupled to a terminal of a voltage source 220, which provides a supply voltage V_{DD}. The second node 204 is furthermore coupled to a first output terminal 221 of the circuit arrangement 200. The third node 207 is coupled to a second output terminal 222 of the circuit arrangement 200, which second output terminal 222 is differential with respect to the first output terminal 221.

Integrated circuit arrangements in modern semiconductor technologies (in particular CMOS technology) for high frequencies have low breakdown voltages. As a result of this, the maximum permissible operating voltages, which are 0.9 V to 1.5 V, for example, for CMOS technology, are limited to small values. For this reason, it is only possible to realize circuits which are formed from few stacked transistors, that is to say transistors arranged one above another.

A stacked concept is used in a conventional 2:1 multiplexer for high clock rates. That is to say that a plurality of transistors are arranged one above another and operated with a supply voltage. One disadvantage of this concept is that at least three transistors are stacked on top of one another, so that the available voltage per transistor is small.

### SUMMARY

An integrated circuit arrangement in accordance with a first embodiment of the invention has at least one multiplexer circuit, the multiplexer circuit having at least one multiplexer stage. The multiplexer stage has a data signal circuit having at least two data input terminals and at least one data output terminal, and also a clock signal circuit having at least one clock signal input. The multiplexer circuit furthermore has a transformer which electrically decouples the data signal circuit and the clock signal circuit and makes a clock signal of the clock signal circuit available as a control signal for the data signal circuit. The transformer has two secondary-side end terminals directly coupled to the data signal circuit, and also a secondary-side center terminal coupled to a bias current source.

An integrated circuit arrangement in accordance with a second embodiment of the invention has at least one latch register circuit, the latch register circuit having at least one latch register stage. The at least one latch register stage has a data signal circuit having at least two data input terminals and at least one data output terminal, and also a clock signal circuit having at least one clock signal input. Furthermore, a transformer is provided which electrically decouples the data signal circuit and the clock signal circuit and makes a clock signal of the clock signal circuit available as a control signal for the data signal circuit. The transformer has two secondary-side end terminals directly coupled to the data signal circuit, and also a secondary-side center terminal coupled to a bias current source.

In accordance with a further embodiment of the invention, an integrated circuit arrangement is provided having at least one multiplexer circuit, the multiplexer circuit having at least one multiplexer stage having a data signal circuit and a clock signal circuit. The integrated circuit arrangement furthermore has a transformer which electrically decouples the data signal circuit and the clock signal circuit and generates a clock signal of the clock signal circuit as a control signal for the data signal circuit. The transformer has a secondary-side center terminal coupled to a bias current source.

In accordance with a further embodiment of the invention, an integrated circuit arrangement is provided having at least one multiplexer circuit. The at least one multiplexer stage has a data signal circuit having at least two data input terminals and at least one data output terminal and a clock signal circuit having at least one clock signal input. The integrated circuit arrangement furthermore has a monolithically integrated transformer which electrically decouples the data signal circuit and the clock signal circuit and makes a clock signal of the clock signal circuit available as a control signal for the data signal circuit. The transformer has two primary-side end terminals coupled to the clock signal circuit, a primary-side center terminal coupled to an electrical reference potential, two secondary-side end terminals directly coupled to the data signal circuit, and a secondary-side center terminal coupled to a bias current source.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates a conventional 2:1 multiplexer circuit.

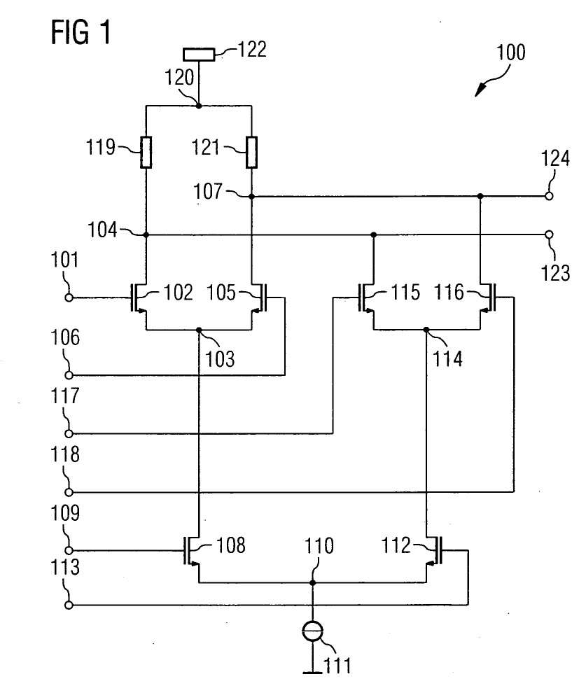

FIG. 2 illustrates a conventional latch register circuit,

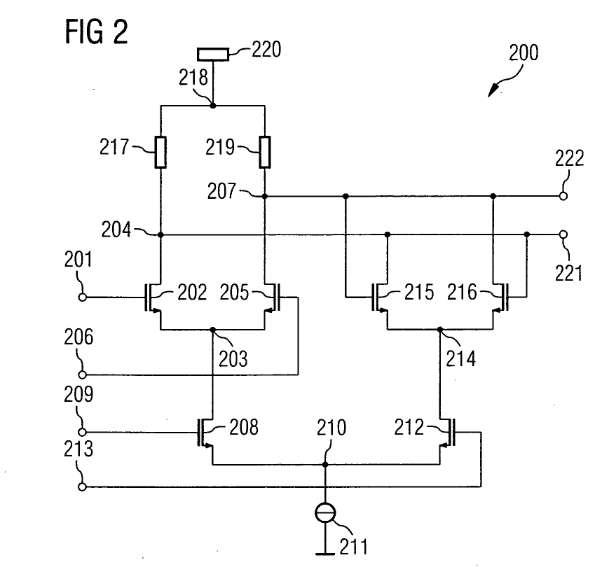

FIG. 3 illustrates a basic circuit diagram of an integrated circuit arrangement including a multiplexer circuit in accordance with one exemplary embodiment of the invention.

FIG. 4 illustrates a schematic circuit diagram of an integrated circuit arrangement including a multiplexer circuit in accordance with one exemplary embodiment of the invention.

FIG. 5 illustrates a schematic diagram of a monolithic transformer.

FIG. 6 illustrates a basic circuit diagram of an integrated circuit arrangement including a latch register circuit in accordance with one exemplary embodiment of the invention.

FIG. 7 illustrates a schematic circuit diagram of an integrated circuit arrangement including a latch register circuit in accordance with one exemplary embodiment of the invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The integrated circuit arrangements in accordance with exemplary embodiments of the invention can be operated by very small operating voltages. By the use of a transformer, the same operating voltage is made available to the transistors of the data signal circuit and to the transistors of the clock signal circuit. Therefore, the operating voltage can be chosen to be smaller than it would have to be chosen in the case of a conventional multiplexer. As a result of this, the integrated circuit arrangement according to the invention can also be used in circuits which have a high operating speed.

The embodiments of the invention which are described below relate both to the integrated circuit arrangement including a multiplexer circuit and to the integrated circuit arrangement including a latch register circuit.

In one embodiment, the transformer may be a monolithically integrated transformer.

The use of a monolithically integrated transformer makes it possible to form the circuit arrangement as an integrated circuit arrangement which is compatible with silicon semiconductor microelectronics.

In accordance with one embodiment of the invention, the transformer is configured in such a way that a center tap is possible both on the primary side and on the secondary side of the transformer.

In accordance with this embodiment of the invention, the transformer may furthermore have:

two primary-side end terminals coupled to the clock signal circuit, and a primary-side center terminal coupled to an electrical reference potential, for example the ground potential.

In accordance with one embodiment of the invention, a number of windings on the primary side of the transformer and also a number of windings on the secondary side of the monolithic transformer are both two, that is to say that the primary side and the secondary side of the transformer have two turns in each case. In an alternative embodiment of the invention, a number of windings on the primary side of the transformer is one and a number of windings on the secondary side of the transformer is four.

The at least one multiplexer stage may be a differential 2:1 multiplexer stage.

A clock frequency of the at least one multiplexer stage is at least 17 GHz, by way of example.

In accordance with one development of the invention, a resonant circuit is formed by capacitances on the primary side of the transformer, the resonant circuit being dimensioned in such a way that it is at resonance with the clock frequency.

By the circuit arrangement according to the invention, the full supply voltage is available both to the data signal circuit and to a clock signal circuit. Furthermore, a primary side of the monolithically integrated transformer is operated at resonance. This results in a large signal level amplification of the clock (clock amplification) on the secondary side of the transformer.

Clearly, one embodiment of the invention can be seen in the fact that the supply voltage is divided between two parts by the transformer, so that the full supply voltage is available to the transistors of the clock signal circuit. Consequently, by way of example, at most two transistors are stacked in these integrated circuit arrangements. As a result, more drain-source voltage remains for each transistor and it is therefore faster. The, for example, monolithically integrated, transformer is tuned at resonance with the capacitances and a clock signal amplification (clock amplification) arises on the secondary side of the transformer. On the multiplexer side or on the latch side, a current source (the bias current source) supplies the bias current at the center tap of the transformer. The current source additionally determines the envelope of the output data signal.

The loads (first impedance and second impedance) may be for example:

a nonreactive resistor,

a nonreactor resistor, connected in series with an inductance, or

a MOS field effect transistor.

The circuit arrangements can be operated at very low supply voltages and have a very high operating speed as a result of the high clock signal gain and the higher drain-source voltage at the transistors.

Exemplary embodiments of the invention are illustrated in the Figures and are explained in more detail below. The same or identical components are provided with identical reference symbols in the figures, insofar as is expedient.

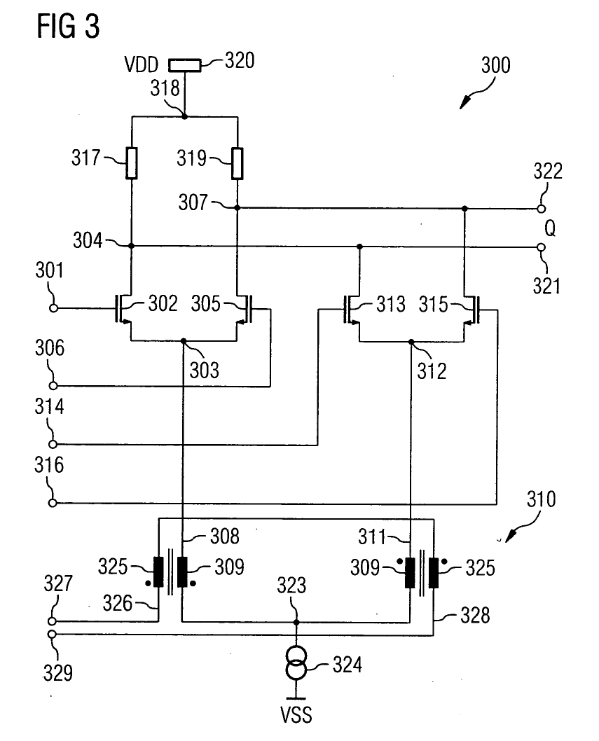

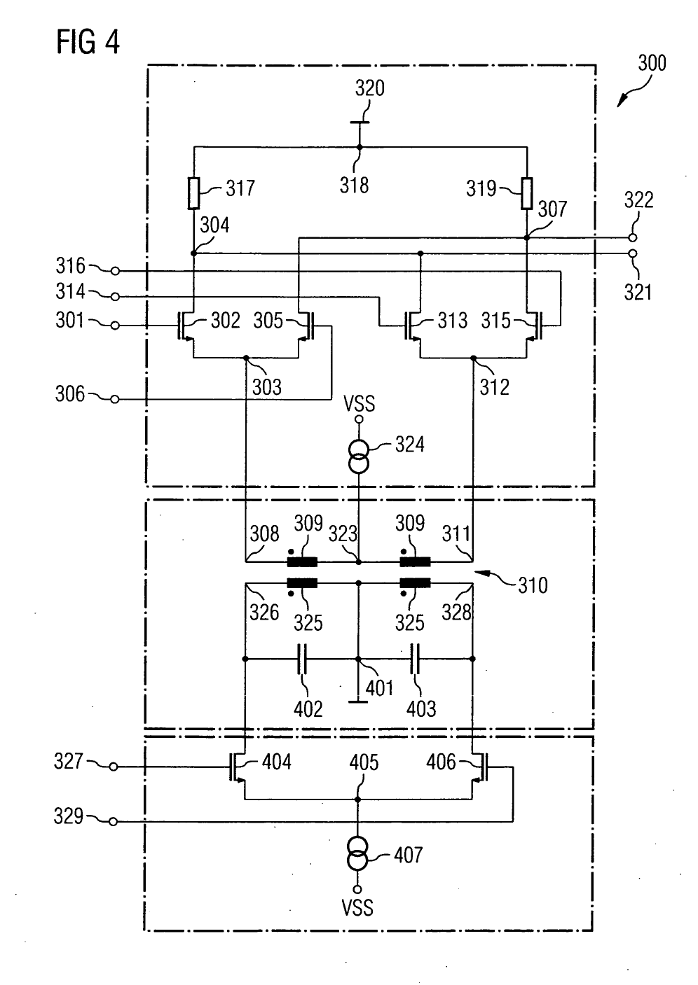

An integrated circuit arrangement 300 including a multiplexer circuit in accordance with a first exemplary embodiment of the invention is described in greater detail referring to FIG. 3 and FIG. 4.

FIG. 3 illustrates a basic circuit diagram of an integrated circuit arrangement 300 including a multiplexer circuit in accordance with a first exemplary embodiment of the invention.

In accordance with these exemplary embodiments of the invention, the transistors are set up as MOS field effect transistors (MOS: Metal Oxide Semiconductor), without restricting the general validity. In alternative embodiments, the transistors are set up as other types of field effect transistors, for example as MIS field effect transistors (MIS: Metal Insulator Semiconductor).

The integrated circuit arrangement 300 has a first data input 301 coupled to the gate of a first transistor 302. The first source/drain region of the first transistor 302 is coupled to a first node 303 and the second source/drain region of the first transistor 302 is coupled to a second node 304. The first node 303 is coupled to a first source/drain region of a second transistor 305. The gate of the second transistor 305 is coupled to a second data input 306, which is differential with respect to the first data input 301. In the context of this application, two differential terminals is understood to mean that if a signal is present at one terminal, the inverse signal is present at the differential terminal with respect to the former terminal.

A second source/drain region of the second transistor 305 is coupled to a third node 307. Furthermore, the first node 303 is coupled to a first end terminal 308 of a secondary winding 309 of a monolithic transformer 310.

A second end terminal 311 of the secondary winding 309 of the monolithic transformer 310 is coupled to a fourth node 312 and, via the latter, to a first source/drain region of a third transistor 313.

The gate of the third transistor 313 is coupled to a third data input 314. A second source/drain region of the second transistor 313 is coupled to the second node 304.

The fourth node 312 is furthermore coupled to a first source/drain region of a fourth transistor 315. The gate of the fourth transistor 315 is coupled to a fourth data input 316, which fourth data input 316 is differential with respect to the third data input 314. A second source/drain region of the fourth transistor 315 is coupled to the third node 307.

The second node 304 is coupled to a fifth node 318 by a first impedance 317.

The third node 307 is likewise coupled to the fifth node 318 by a second impedance 319. The fifth node 318 is coupled to a voltage source 320, which provides a supply voltage V_{DD}.

The second node 304 is furthermore coupled to a first output terminal 321 of the circuit arrangement 300. The third node 307 is furthermore coupled to a second output terminal 322 of the circuit arrangement 300, which second output terminal 322 is differential with respect to the first output terminal 321.

A sixth node 323 is arranged within the secondary winding 309 of the monolithic transformer 310. The sixth node 323 is used as a center tap of the secondary winding 309. The sixth node 323 is coupled to a first terminal of a bias current source 324, which provides a bias current. In accordance with this embodiment of the invention, the bias current source 324 provides a bias current having a magnitude of 5 mA. A second terminal of the bias current source 324 is coupled to a reference potential V_{SS}, for example the ground potential.

The monolithic transformer 310 furthermore has a primary winding 325. A first end terminal 326 of the primary winding 325 is coupled to a first clock signal input 327. A second end terminal 328 of the primary winding 325 is coupled to a second clock signal input 329.

On the multiplexer side, the bias current source 324 thus supplies the bias current at the center tap 323 of the transformer 310. The bias current source 324 additionally determines the envelope of the output data signal provided at the first output terminal 321 or at the second output terminal 322.

As is illustrated in more specific detail in FIG. 4, a clock signal circuit is connected between the end terminals 326, 328, the construction of the clock signal circuit being described below.

A seventh node 401 is arranged within the primary winding 325. The seventh node 401 is used as a center tap of the primary winding 325.

The first end terminal 326 of the primary winding 325 is coupled to a first electrode of a first capacitor 402. A second electrode of the first capacitor 402 is coupled to the seventh node 401. Furthermore, the seventh node 401 is coupled to a first electrode of a second capacitor 403. A second electrode of the second capacitor 403 is coupled to the second end terminal 328 of the primary winding 325. Furthermore, the seventh node 401 is connected to ground potential.

Furthermore, the first end terminal 326 of the primary winding 325 is coupled to a first source/drain region of a fifth transistor 404. The gate of the fifth transistor 404 is coupled to the first clock signal input 327. The second source/drain region of the fifth transistor 404 is coupled to an eighth node 405. The eighth node 405 is coupled to a first source/drain region of a sixth transistor 406. The gate of the sixth transistor 406 is coupled to the second clock signal input 329, which second clock signal input 329 is differential with respect to the first clock signal input 327. The second source/drain region of the sixth transistor 406 is coupled to the second end terminal 328 of the primary winding 325.

The eighth node 405 is coupled to the reference potential V_{SS} by a further current source 407.

In the exemplary embodiment described, the first impedance 317 and the second impedance 319 each have a value of 70 ohms. The impedances (load) may be e.g. nonreactive resistors, nonreactive resistors connected in series with an inductance, or MOS transistors. The applied clock signal has a frequency of 17 GHz. The first transistor 302, the second transistor 305, the third transistor 313 and the fourth transistor 315 have a gate length of 120 nm and a gate width of 20 μm, while the fifth transistor 404 and the sixth transistor 406 have a gate length of 120 nm and a gate width of 50 μm. In the exemplary embodiment, the monolithic transformer 310 has a winding ratio of 2:2, and a winding ratio of 4:1 in an alternative embodiment of the invention.

The monolithically integrated transformer 310 is tuned at resonance with the first capacitor 402 and the second capacitor 403. The resulting resonance behavior brings about a high clock amplification on the secondary side of the monolithic transformer 310.

The first transistor 302, the second transistor 305, the third transistor 313 and the fourth transistor 315 are part of a data signal circuit of the multiplexer.

The fifth transistor 404 and the sixth transistor 406 are part of a clock signal circuit of the multiplexer.

The parallel/serial conversion of the signals present in parallel at the two inputs, to put it another way the combining of the two input signals to form a common output signal provided at the output of the 2:1 multiplexer, is achieved thereby. The multiplexer functionality is realized thereby.

By the use of the transformer having a center tap, the full supply voltage is available both to the clock signal circuit and to the data signal circuit. This is advantageous particularly for an integrated circuit arrangement including at least one multiplexer which is formed using CMOS technology, since only small supply voltages are available in this technology. At most two stages of transistors are stacked in the circuit arrangement 300 in accordance with this exemplary embodiment of the invention. This means that the entire supply voltage is dropped across in each case at most two transistors which are connected in series. A larger potential difference is thus present at each individual transistor.

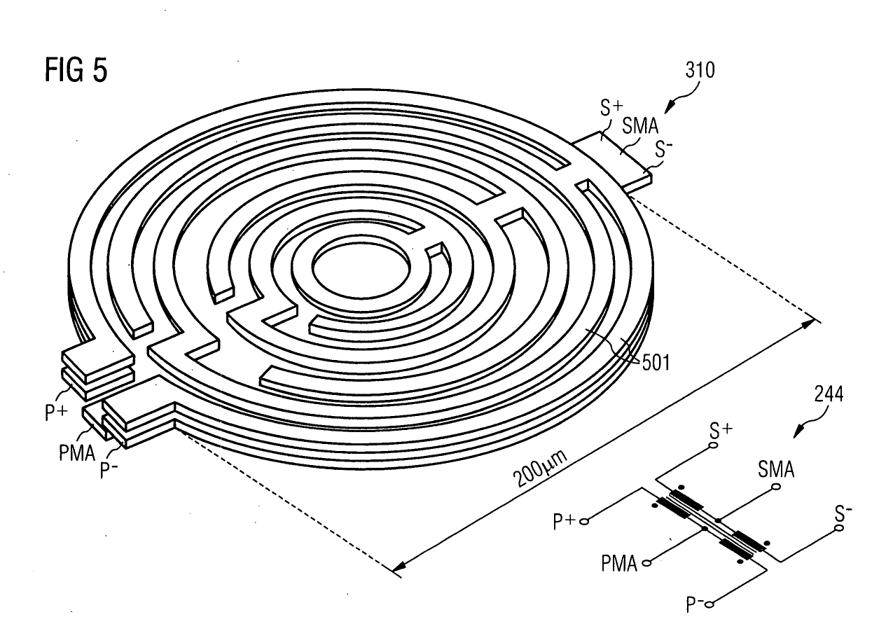

FIG. 5 illustrates an example of a monolithically integrated transformer 310. The monolithically integrated transformer 310 has a spiral arrangement of turns 501 which essentially lie in two parallel planes and have an external diameter of approximately 200 μm. It furthermore has a primary winding side having a first terminal P+ and a second terminal P− and a secondary winding side having a first terminal S+ and a second terminal S−. In addition, the primary winding side and the secondary winding side have a center terminal PMA and SMA, respectively. In the exemplary embodiment described above, the center terminal of the primary winding side PMA is connected to ground, while the center terminal of the secondary winding side SMA is connected to a supply voltage.

FIG. 5 additionally illustrates the equivalent circuit diagram 502 corresponding to the transformer 310 in the same orientation as the transformer 111.

In accordance with the exemplary embodiment of the invention, it is possible to use all monolithically integrated transformers which have a center tap both on the primary side and on the secondary side of the transformer.

The use of a monolithically integrated transformer 310 in an integrated circuit arrangement 300 including at least one multiplexer stage is advantageous particularly in the case of narrowband clock signals.

To summarize, the exemplary embodiment of the invention provides an integrated circuit arrangement including a multiplexer stage in which a data signal circuit and a clock signal circuit are electrically decoupled from one another by the use of a monolithically integrated transformer. The use of a transformer with a center tap both on the primary side and on the secondary side of the transformer means that the full supply voltage can be provided both to the data signal circuit and to the clock signal circuit by virtue of the center tap on the primary side being connected to ground and the center tap of the secondary side being connected to the supply voltage. In order to additionally improve the performance (clock frequency and operating speed) of the integrated circuit arrangement including a multiplexer stage, capacitors are arranged on the primary side of the transformer, the clock signal circuit, the capacitors being dimensioned in such a way that a circuit which is at resonance at the applied clock rate is formed on the primary side. A large clock signal, that is to say a clock signal having a large signal level, is available on the secondary side as a result of this.

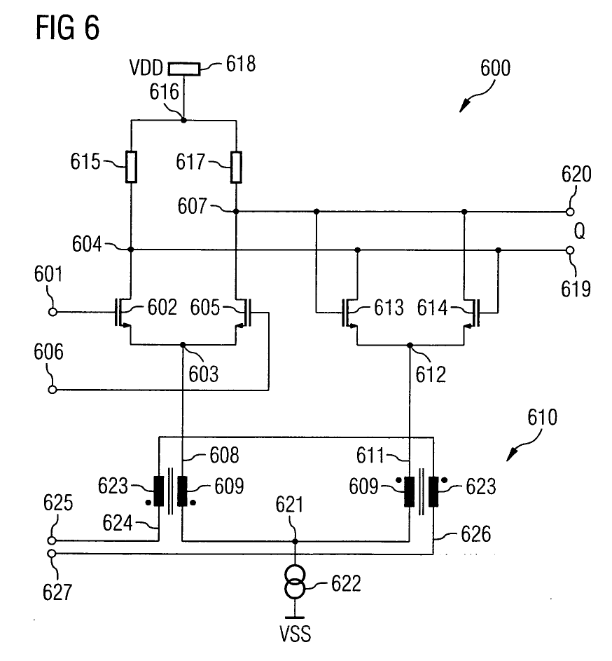

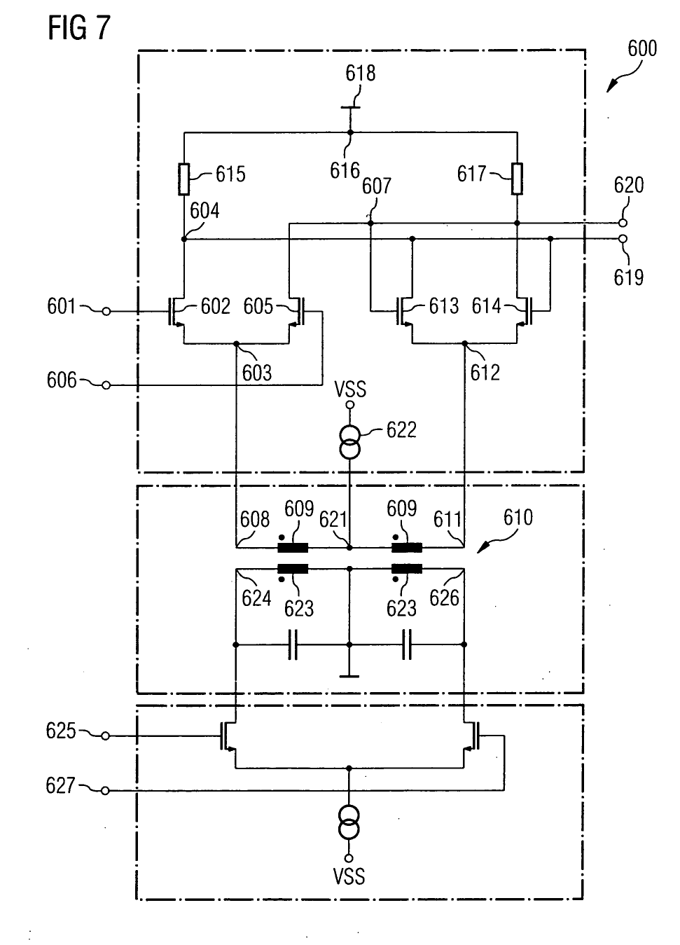

An integrated circuit arrangement 600 including a multiplexer circuit in accordance with a second exemplary embodiment of the invention is described in more detail referring to FIG. 6 and FIG. 7.

FIG. 6 illustrates a basic circuit diagram of an integrated circuit arrangement 300 including a latch register circuit (also referred to hereinafter as a latch circuit) in accordance with a second exemplary embodiment of the invention.

In accordance with these exemplary embodiments of the invention, the transistors are set up as MOS field effect transistors (MOS: Metal Oxide Semiconductor), without restricting the general validity. In alternative embodiments, the transistors are set up as other types of field effect transistors, for example as MIS field effect transistors (MIS: Metal Insulator Semiconductor).

The integrated circuit arrangement 600 has a first data input 601 coupled to the gate of a first transistor 602. The first source/drain region of the first transistor 602 is coupled to a first node 603 and the second source/drain region of the first transistor 602 is coupled to a second node 604. The first node 603 is coupled to a first source/drain region of a second transistor 605. The gate of the second transistor 605 is coupled to a second data input 606, which is differential with respect to the first data input 601.

A second source/drain region of the second transistor 605 is coupled to a third node 607. Furthermore, the first node 603 is coupled to a first end terminal 608 of a secondary winding 609 of a monolithic transformer 610.

A second end terminal 611 of the secondary winding 609 of the monolithic transformer 610 is coupled to a fourth node 612 and, via the latter, to a first source/drain region of a third transistor 613.

The gate of the third transistor 613 is coupled to the node 607. A second source/drain region of the third transistor 613 is coupled to the second node 304.

The fourth node 612 is furthermore coupled to a first source/drain region of a fourth transistor 614. The gate of the fourth transistor 614 is coupled to the second node 604. A second source/drain region of the fourth transistor 614 is coupled to the third node 607.

The second node 604 is coupled to a fifth node 616 by a first impedance 615.

The third node 607 is likewise coupled to the fifth node 616 by a second impedance 617. The fifth node 616 is coupled to a voltage source 618, which provides a supply voltage V_{DD}.

The second node 604 is furthermore coupled to a first output terminal 619 of the circuit arrangement 600. The third node 607 is furthermore coupled to a second output terminal 620 of the circuit arrangement 600, which second output terminal 620 is differential with respect to the first output terminal 619.

A sixth node 621 is arranged within the secondary winding 609 of the monolithic transformer 610. The sixth node 621 is used as a center tap of the secondary winding 609. The sixth node 621 is coupled to a first terminal of a bias current source 622, which provides a bias current. In accordance with this embodiment of the invention, the bias current source 622 provides a bias current having a magnitude of 5 mA. A second terminal of the bias current source 622 is coupled to a reference potential V_{SS}, for example the ground potential.

The monolithic transformer 610 furthermore has a primary winding 623. A first end terminal 624 of the primary winding 623 is coupled to a first clock signal input 625. A second end terminal 626 of the primary winding 623 is coupled to a second clock signal input 627.

On the multiplexer side, the bias current source 622 thus supplies the bias current at the center tap 621 of the transformer 610. The bias current source 622 additionally determines the envelope of the output data signal provided at the first output terminal 619 or at the second output terminal 620.

As is illustrated in more specific detail in FIG. 7, a clock signal circuit is connected between the end terminals 624, 626, the construction of the clock signal circuit being described below.

A seventh node 701 is arranged within the primary winding 623. The seventh node 701 is used as a center tap of the primary winding 623.

The first end terminal 624 of the primary winding 623 is coupled to a first electrode of a first capacitor 702. A second electrode of the first capacitor 702 is coupled to the seventh node 701. Furthermore, the seventh node 701 is coupled to a first electrode of a second capacitor 703. A second electrode of the second capacitor 703 is coupled to the second end terminal 626 of the primary winding 623. Furthermore, the seventh node 701 is connected to ground potential.

Furthermore, the first end terminal 624 of the primary winding 623 is coupled to a first source/drain region of a fifth transistor 704. The gate of the fifth transistor 704 is coupled to the first clock signal input 625. The second source/drain region of the fifth transistor 704 is coupled to an eighth node 705. The eighth node 705 is coupled to a first source/drain region of a sixth transistor 706. The gate of the sixth transistor 706 is coupled to the second clock signal input 627, which second clock signal input 627 is differential with respect to the first clock signal input 625. The second source/drain region of the sixth transistor 706 is coupled to the second end terminal 626 of the primary winding 623.

The eighth node 705 is coupled to the reference potential V_{SS} by a further current source 707.

In the exemplary embodiment described, the first impedance 615 and the second impedance 617 each have a value of 70 ohms. The impedances (load) may be e.g. nonreactive resistors, nonreactive resistors connected in series with an inductance, or MOS transistors. The applied clock signal has a frequency of 17 GHz. The first transistor 602, the second transistor 605, the third transistor 613 and the fourth transistor 614 have a gate length of 120 nm and a gate width of 20 μm, while the fifth transistor 704 and the sixth transistor 706 have a gate length of 120 nm and a gate width of 50 μm. In the exemplary embodiment, the monolithic transformer 610 has a winding ratio of 2:2, and a winding ratio of 4:1 in an alternative embodiment of the invention.

The monolithically integrated transformer 610 is tuned at resonance with the first capacitor 702 and the second capacitor 703. The resulting resonance behavior brings about a high clock amplification on the secondary side of the monolithic transformer 610.

The first transistor 602, the second transistor 605, the third transistor 613 and the fourth transistor 614 are part of a data signal circuit of the latch.

The fifth transistor 704 and the sixth transistor 706 are part of a clock signal circuit of the latch.

By the use of the transformer having a center tap, the full supply voltage is available both to the clock signal circuit and to the data signal circuit. This is advantageous particularly for an integrated circuit arrangement including at least one multiplexer which is formed using CMOS technology, since only small supply voltages are available in this technology. At most two stages of transistors are stacked in the circuit arrangement 600 in accordance with this exemplary embodiment of the invention. This means that the entire supply voltage is dropped across in each case at most two transistors which are connected in series. A larger potential difference is thus present at each individual transistor.

The circuit arrangement 600 in accordance with the second exemplary embodiment of the invention has the same monolithically integrated transformer as the circuit arrangement 300 in accordance with the first exemplary embodiment of the invention, as was described above referring to FIG. 5.

The use of a monolithically integrated transformer 610 in an integrated circuit arrangement 600 including at least one latch stage is advantageous particularly in the case of narrowband clock signals.

To summarize, the exemplary embodiment of the invention provides an integrated circuit arrangement including a latch stage in which a data signal circuit and a clock signal circuit are electrically decoupled from one another by the use of a monolithically integrated transformer. The use of a transformer with a center tap both on the primary side and on the secondary side of the transformer means that the full supply voltage can be provided both to the data signal circuit and to the clock signal circuit by virtue of the center tap on the primary side being connected to ground and the center tap of the secondary side being connected to the supply voltage. In order to additionally improve the performance (clock frequency and operating speed) of the integrated circuit arrangement including a latch stage, capacitors are arranged on the primary side of the transformer, the clock signal circuit, the capacitors being dimensioned in such a way that a circuit which is at resonance at the applied clock rate is formed on the primary side. A large clock signal, that is to say a clock signal having a large signal level, is available on the secondary side as a result of this.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. (canceled)

2.-20. (canceled)

21. An integrated circuit arrangement, comprising:
at least one multiplexer circuit, the multiplexer circuit having at least one multiplexer stage having a data signal circuit and a clock signal circuit;
a transformer configured to electrically decouple the data signal circuit and the clock signal circuit and generates a clock signal of the clock signal circuit as a control signal for the data signal circuit; and
the transformer having a secondary-side center terminal coupled to a bias current source.

22. The integrated circuit arrangement of claim 21, comprising wherein the transformer is a monolithically integrated transformer.

23. The integrated circuit arrangement of claim 21, the transformer comprising:
two primary-side end terminals coupled to the clock signal circuit; and
a primary-side center terminal coupled to an electrical reference potential.

24. The integrated circuit arrangement of claim 23, comprising wherein the electrical reference potential is the ground potential.

25. An integrated circuit arrangement, comprising:
at least one multiplexer circuit, the multiplexer circuit having at least one multiplexer stage comprising:
a data signal circuit having at least two data input terminals and at least one data output terminal;
a clock signal circuit having at least one clock signal input;
a transformer configured to electrically decouple the data signal circuit and the clock signal circuit and configured to make a clock signal of the clock signal circuit available as a control signal for the data signal circuit, the transformer comprising:
two secondary-side end terminals directly coupled to the data signal circuit; and
a secondary-side center terminal coupled to a bias current source.

26. The integrated circuit arrangement of claim 25, comprising wherein the transformer is a monolithically integrated transformer.

27. The integrated circuit arrangement of claim 25, the transformer comprising:
two primary-side end terminals coupled to the clock signal circuit; and
a primary-side center terminal coupled to an electrical reference potential.

28. The integrated circuit arrangement of claim 27, comprising wherein the electrical reference potential is the ground potential.

29. The integrated circuit arrangement of claim 25, comprising wherein the number of windings on the primary side of the transformer and the number of windings on the secondary side of the monolithic transformer both are two, or the number of windings on the primary side of the transformer being one and the number of windings on the secondary side of the transformer are four.

30. The integrated circuit arrangement of claim 25, comprising wherein at least one multiplexer stage is a differential 2:1 multiplexer stage.

31. The integrated circuit arrangement of claim 25, comprising wherein the clock frequency of the at least one multiplexer stage is at least 17 GHz.

32. The integrated circuit arrangement of claim 25, wherein a resonant circuit comprising capacitances, formed on the primary side of the transformer, which is at resonance with the clock frequency.

33. An integrated circuit arrangement, comprising:
at least one latch register circuit having at least one latch register stage;
the at least one latch register stage comprising:
a data signal circuit having at least two data input terminals and at least one data output terminal;
a clock signal circuit having at least one clock signal input; and
a transformer configured to electrically decouple the data signal circuit and the clock signal circuit and configured to make a clock signal of the clock signal circuit available as a control signal for the data signal circuit;
the transformer comprising:
two secondary-side end terminals directly coupled to the data signal circuit; and
a secondary-side center terminal coupled to a bias current source.

34. The integrated circuit arrangement of claim 33, comprising wherein the transformer is a monolithically integrated transformer.

35. The integrated circuit arrangement of claim 33, the transformer comprising:
two primary-side end terminals coupled to the clock signal circuit; and
a primary-side center terminal coupled to an electrical reference potential.

36. The integrated circuit arrangement of claim 35, comprising wherein the electrical reference potential is the ground potential.

37. The integrated circuit arrangement of claim 33, comprising wherein the number of windings on the primary side of the transformer and also the number of windings on the secondary side of the monolithic transformer both are two, or the number of windings on the primary side of the transformer being one and the number of windings on the secondary side of the transformer are four.

38. The integrated circuit arrangement of claim 33, comprising wherein the clock frequency of the at least one latch register stage is at least 17 GHz.

39. The integrated circuit arrangement of claim 33, wherein a resonant circuit comprising capacitances, formed on the primary side of the transformer, which is at resonance with the clock frequency.

40. A monolithically integrated circuit arrangement, comprising:
at least one multiplexer circuit;
the multiplexer circuit having at least one multiplexer stage comprising:
a data signal circuit having at least two data input terminals and at least one data output terminal;
a clock signal circuit having at least one clock signal input;
a monolithically integrated transformer which electrically decouples the data signal circuit and the clock signal circuit and makes a clock signal of the clock signal circuit available as a control signal for the data signal circuit, the transformer comprising:
two primary-side end terminals coupled to the clock signal circuit;
a primary-side center terminal coupled to an electrical reference potential;
two secondary-side end terminals directly coupled to the data signal circuit; and
a secondary-side center terminal coupled to a bias current source.

41. An integrated circuit arrangement, comprising:
at least one multiplexer circuit, the multiplexer circuit having at least one multiplexer stage having a data signal circuit and a clock signal circuit;
means for providing a transformer configured to electrically decouple the data signal circuit and the clock signal circuit and generates a clock signal of the clock signal circuit as a control signal for the data signal circuit; and
the transformer having a secondary-side center terminal coupled to a bias current source.
